(19) United States
(12) Patent Application Publication
(10) Pub. No.: US 2017/0109802 A1
(43) Pub. Date: Apr. 20, 2017

(54) THIRD PARTY PAYMENT PROVIDER ASSISTED ONLINE PAYMENT PROCESSING

(71) Applicant: International Business Machines Corporation, Armonk, NY (US)

(72) Inventors: Ravi Kothari, New Delhi (IN); Apurva Kumar, Noida (IN)

(21) Appl. No.: 14/887,738

(22) Filed: Oct. 20, 2015

(51) Int. Cl. G06Q 30/06; G06Q 20/40

(52) U.S. Cl. CPC G06Q 30/0613; G06Q 30/0641; G06Q 20/4014

(57) ABSTRACT

A contemplated method is third party assisted online payment processing, including: utilizing at least one processor to execute computer code that performs steps comprising: receiving, at a third party payment provider, a user selection communicated through an on-line shopping cart of a merchant, wherein the user selection identifies a bank and an alias; communicating to the bank associated with the user selection, using a network connection between the third party payment provider and the bank, the alias and an identification of the third party payment provider; receiving from the bank, at the third party payment provider and in response to the communicating, authorization for payment on behalf of the user; and providing, to the on-line shopping cart of the merchant, payment information; where the third party payment provider does not receive at any time a primary account number of the bank issued to the user. Other aspects are described and claimed.

### BACKGROUND

Utilization of online payment processing has increased markedly and promises to continue to do so. One of the reasons for the increase is the convenience online shopping offers. Internet merchants compete with each other in offering the best user experience, e.g., convenient check out processing using shopping cart applications. Third party payment providers, so-called virtual wallets, have become popular given their ability to collect multiple payments sources of a user and make these available for use online during the checkout process.

Even with the use of virtual wallets, a difficult part of a customer's online shopping experience remains the checkout process. User experience is one of the key considerations for merchants when choosing a payment gateway to integrate with banks. Payment processing involves a lot of factors outside of the merchant's expertise and control; consequently, a merchant often must depend on third party payment providers (TPPPs) to assist in the payment processing. However, although virtual wallet services offered by TPPPs offer convenience, convenience itself is of little use without security. Thus, it must be ensured that the improved usability of a virtual wallet service does not come at the cost of compromising security.

### BRIEF SUMMARY

In summary, one aspect of the invention provides a method of third party assisted online payment processing, comprising: utilizing at least one processor to execute computer code that performs steps comprising: receiving, at a third party payment provider, a user selection communicated through an on-line shopping cart of a merchant, wherein the user selection identifies a bank and an alias; communicating to the bank associated with the user selection, using a network connection between the third party payment provider and the bank, the alias and an identification of the third party payment provider; receiving from the bank, at the third party payment provider and in response to the communicating, authorization for payment on behalf of the user; and providing, to the on-line shopping cart of the merchant, payment information; wherein the third party payment provider does not receive at any time a primary account number of the bank issued to the user.

Another aspect of the present invention provides an apparatus for third party assisted online payment processing, the apparatus comprising: at least one processor; and a computer readable storage medium having computer readable program code embodied therewith that is executable by the at least one processor, the computer readable program code comprising: computer readable program code that receives, at a third party payment provider, a user selection communicated through an on-line shopping cart of a merchant, wherein the user selection identifies a bank and an alias; computer readable program code that communicates to the bank associated with the user selection, using a network connection between the third party payment provider and the bank, the alias and an identification of the third party payment provider; computer readable program code that receives from the bank, at the third party payment provider and in response to the communicating, authorization for payment on behalf of the user; and computer readable program code that provides, to the on-line shopping cart of the merchant, payment information; wherein the third party payment provider does not receive at any time a primary account number of the bank issued to the user.

A further aspect of the present invention provides a computer program product for third party assisted online payment processing, the computer program product comprising: a computer readable storage medium having computer readable program code embodied therewith, the computer readable program code being executable by a processor and comprising: computer readable program code that receives, at a third party payment provider, a user selection communicated through an on-line shopping cart of a merchant, wherein the user selection identifies a bank and an alias; computer readable program code that communicates to the bank associated with the user selection, using a network connection between the third party payment provider and the bank, the alias and an identification of the third party payment provider; computer readable program code that receives from the bank, at the third party payment provider and in response to the communicating, authorization for payment on behalf of the user; and computer readable program code that provides, to the on-line shopping cart of the merchant, payment information; wherein the third party payment provider does not receive at any time a primary account number of the bank issued to the user.

A further aspect of the present invention provides a method of third party assisted online payment processing, comprising: utilizing at least one processor to execute computer code that performs steps comprising: initiating a third party payment provider, the initiating comprising: receiving from a user, at the third party payment provider, an indication of one or more banks to be used in online payment transactions; redirecting, from the third party payment provider, the user to a bank portal of the one or more banks; and receiving, at the third party payment provider, an alias from the one or more banks; thereafter receiving, at the third party payment provider, a user selection communicated through an on-line shopping cart of a merchant, wherein the user selection identifies a bank and an alias; communicating to the bank associated with the user selection, using a network connection between the third party payment provider and the bank, the alias and an identification of the third party payment provider; receiving from the bank, at the third party payment provider and in response to the communicating, authorization for payment on behalf of the user; and providing, to the on-line shopping cart of the merchant, payment information; wherein the third party payment provider does not receive at any time a primary account number of the bank issued to the user.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 illustrates an example of initiating a third party payment provider according to an embodiment of the invention.

FIG. 2 illustrates an example of device communications used in the initiating outlined in FIG. 1.

FIG. 3 illustrates an example of third party payment provider assisted online payment processing according to an embodiment of the invention.

FIG. 4 illustrates an example of device communications used in the payment processing outlined in FIG. 3.

FIG. 5 illustrates an example computer system.

### DETAILED DESCRIPTION

It will be readily understood that the components of the embodiments of the invention, as generally described and illustrated in the figures herein, may be arranged and designed in a wide variety of different configurations in addition to the described example embodiments. Thus, the following more detailed description of the embodiments of the invention, as represented in the figures, is not intended to limit the scope of the embodiments of the invention, as claimed, but is merely representative of example embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are provided to give a thorough understanding of embodiments of the invention. One skilled in the relevant art may well recognize, however, that embodiments of the invention can be practiced without at least one of the specific details thereof, or can be practiced with other methods, components, materials, et cetera. In other instances, well-known structures, materials, or operations are not shown or described in detail to avoid obscuring aspects of the invention.

An embodiment addresses the concern of balancing usability, security and trust in online payment processing by addressing some of the key problems in existing solutions. The concepts of usability and security are often in conflict when designing an online payment processing system. Most often, the easier an online payment processing system is to use, the harder it is to protect.

In a typical online debit or credit card payment processing technique, a user is required to furnish several details to the online merchant web site (or application) or the third party payment provider (TPPP, also referred to herein as a virtual wallet service). The details include for example the user's primary account number (PAN) (e.g., credit card number) issued by a bank, the expiration date of the card number, card verification value (CVV) or batch number, name, address, etc. Entering this information for every transaction at the online merchant's web site is cumbersome, especially on mobile devices. Thus, TPPPs allow users to register payment cards, giving rise to a virtual wallet service. The virtual wallet service may either be specific to a retailer or a cross-merchant solution.

Virtual wallet services significantly simplify the online checkout process. While users trust the online merchants and TPPPs offering such services, and indeed these parties are required to go through stringent compliance processes for storing users' payment credentials, security breaches resulting in leakage of this information are common. For example, data breaches targeting credit card information are frequently reported. Moreover, there is no mechanism preventing such leaked information from being registered in a virtual wallet service. Therefore, there remains a risk associated with storing such information at yet another location, i.e., a TPPP, and for permitting at TPPP to use PANs directly.

Another problem with the virtual wallet services offered by TPPPs is that regulations in many countries or jurisdictions mandate that merchants (or TPPPs on their behalf) integrate with an additional authentication workflow that includes the issuing bank and the credit card network. This is commonly accomplished using an additional password (e.g., MASTERCARD SECURECODE pass code, VERIFIEDBYVISA pass code, etc.) or use of a one-time password. While such techniques, known as “3D secure,” significantly reduce credit card fraud, this adds an additional step to the check out processing, i.e., at least partially defeating the convenience offered by using a virtual wallet service. Thus, using conventional 3D secure processing, the user must perform dual authentication, i.e., once with the TPPP and then again with the bank or credit card network.

An embodiment therefore implements a TPPP virtual wallet service that does not suffer from the above security and usability drawbacks. In an embodiment, a trusted relationship between the bank and the TPPP may be leveraged by the user such that the user need not provide the TPPP any actual payment credentials at any time.

The illustrated embodiments of the invention will be best understood by reference to the figures. The following description is intended only by way of example and simply illustrates certain selected example embodiments of the invention as claimed herein. It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises at least one executable instruction for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

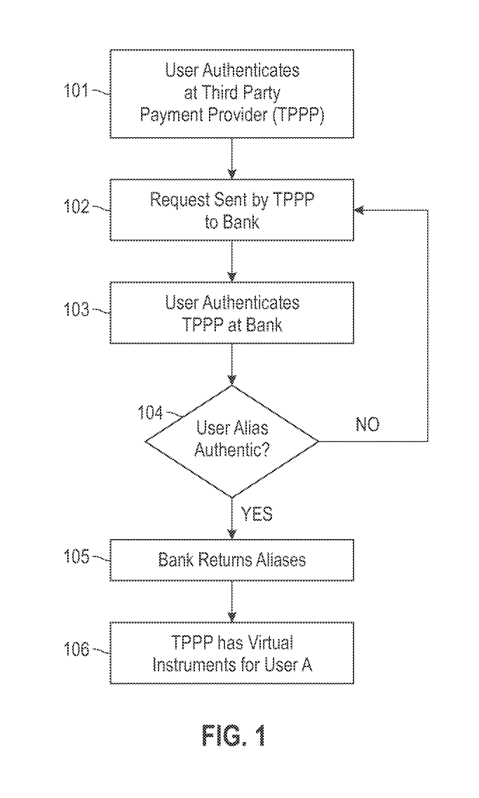

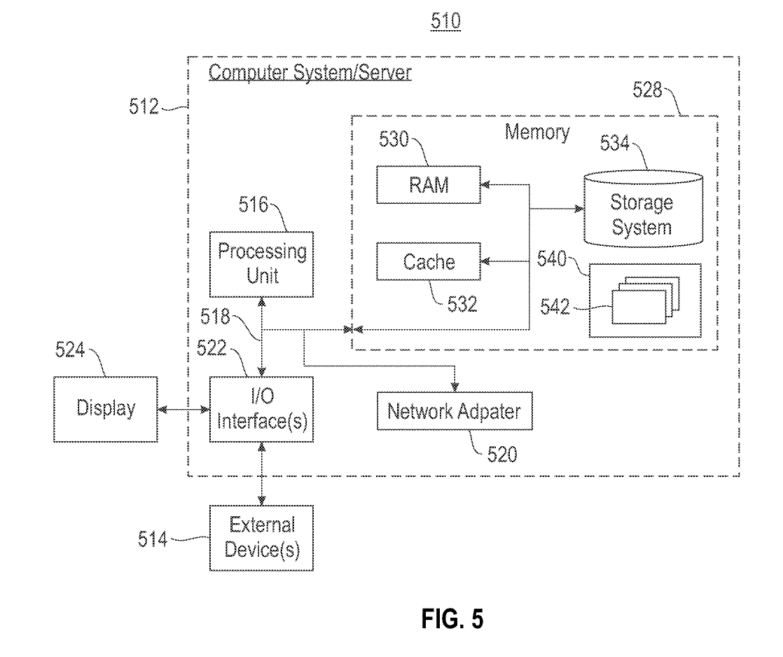

Specific reference will be made to FIGS. 1-5. It should be appreciated that the processes, arrangements and products broadly illustrated therein can be carried out on, or in accordance with, essentially any suitable computer system or set of computer systems, which may, by way of an illustrative and non-restrictive example, include a system or server such as that indicated at 512 in FIG. 5. In accordance with an example embodiment, most if not all of the process steps, components and outputs discussed with respect to FIGS. 1-4 can be performed or utilized by way of a processing unit or units and system memory such as those indicated, respectively, at 516 and 528 in FIG. 5, whether on a server computer, a client computer, a node computer in a distributed network, or any combination thereof.

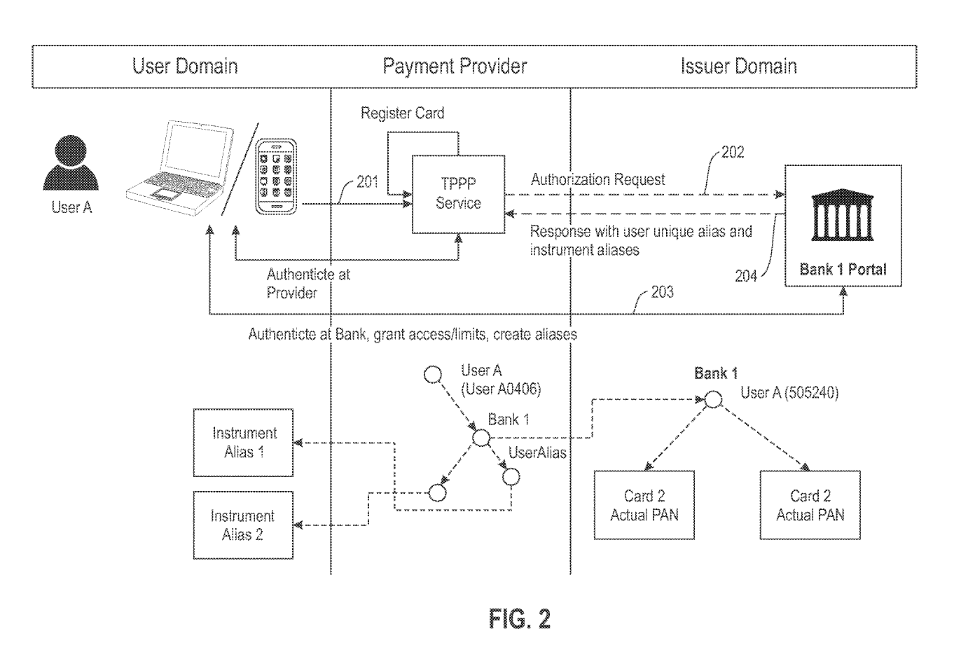

FIG. 1 illustrates a method of linking bank issued payment instruments with a third party payment provider (TPPP) according to an embodiment. Reference will be made to FIG. 2 in connection with the method illustrated in FIG. 1, as FIG. 2 illustrates an example network in which devices communicate to accomplish the registration or initiation process.

Starting at either 101 or 103, a user initiates a TPPP for use by authenticating himself or herself with the TPPP and the bank. For example, at 101 a user sets up or initiates a virtual wallet account at the TPPP and receives a TPPP user login and password for using the TPPP's virtual wallet service. In contrast to conventional virtual wallet services, the TPPP is never provided with the user's primary account number(s) (PAN(s)) issued by the bank(s). Thus, the user need not enter his or her credit card number into the TPPP's system in order to use the virtual wallet service. This prevents the potential for the TPPP to leak or otherwise expose the user's PANs, e.g., in the event of a breach of the TPPP system. Rather, the TPPP has the user's alias and instrument aliases stored due provision of the same by the bank, as further described herein.

Likewise, at 103 the user authenticates at his or her bank and authorizes the TPPP. This may be accomplished by independent connection to a bank portal, as illustrated at 203 of FIG. 2. The user is authenticated by the bank portal and the user informs the bank that the TPPP is authorized to use the user's PANs at the bank, e.g., for a particular amount, for a particular time, etc. The bank generates a user alias for use of the TPPP and as well as instrument aliases for the users PANs at the bank. Thus, the bank and the TPPP are linked by user actions at 101 and 103. The user is permitted to set limits on the use of the user alias and instrument aliases by the TPPP. The TPPP and the bank have a trusted relationship such that the TPPP is confident that the bank will honor its commitments to pay on behalf of the user.

At 102 the TPPP may issue a request from the TPPP web site (or native application) to the bank web site or portal, on behalf of the user, to obtain the user alias and the instrument aliases for future payments. The bank, for its part, determines at 104 if the user request is authentic and replies to the TPPP with the user alias and the instrument aliases. If the user request fails to authenticate at the bank, an error message may be provided to the TPPP and in turn to the user. Otherwise, the bank will confirm that the user request is authentic at 104 and provide a confirmation, along with a user alias and instrument aliases, to the TPPP on behalf of the user at 105. Thus, the user has therefore successfully registered a valid payment method with the TPPP, which now has the aliases provided by the bank, as indicated at 106 of FIG. 1, for use in subsequent online transactions with online merchants.

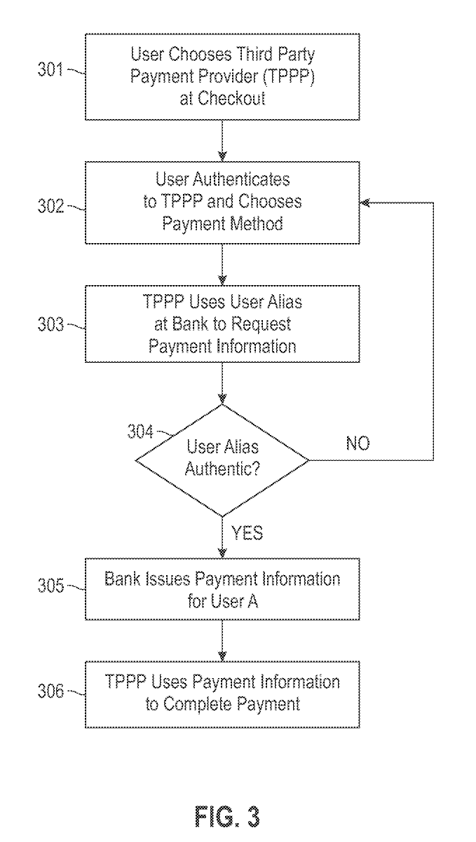

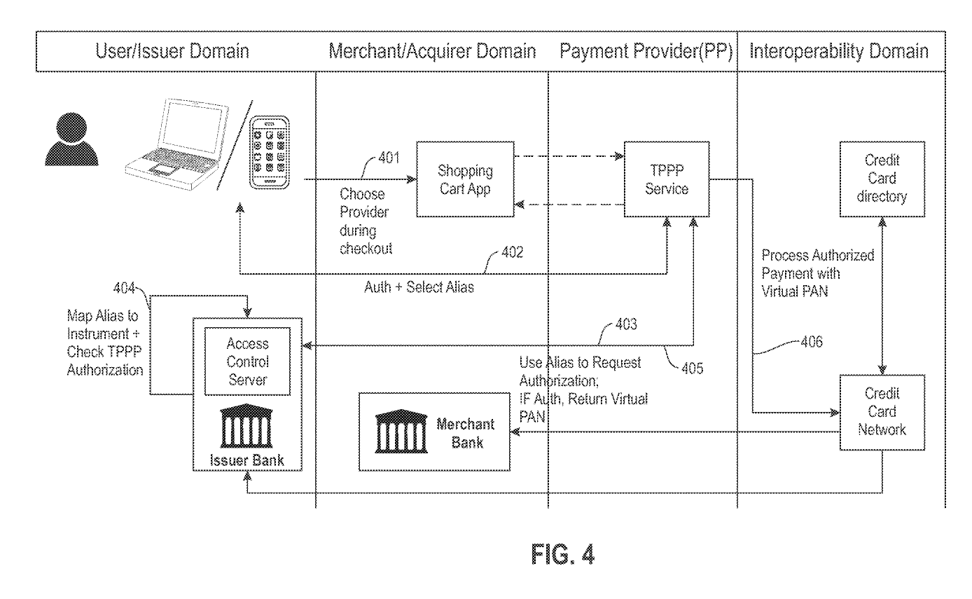

Therefore, the TPPP does not have access to or store the user's PANs and may process online payments on behalf of the user without ever needing the PANs. An example of online payment processing will be described in connection with FIG. 3 and FIG. 4.

Referring specifically to FIG. 2, a TPPP virtual wallet service facilitates payments without the need for sharing sensitive payment information (such as actual credit card numbers) with the TPPP. Unlike existing techniques, the TPPP does not handle sensitive payment credentials, either at the time of registration or during the payment process. During the registration or initiation process, a user (e.g., User A in FIG. 2) specifies a payment method (e.g., a bank name) rather than providing a credit card or PAN number to the TPPP service. User A has the option of linking one or more payment instruments or one or more banks with the TPPP service via this selection. In FIG. 2, only one bank (Bank 1) is illustrated for simplicity.

User A will initially use his or her device (e.g., smart phone, laptop computer, tablet computer, etc.) to initiate a connection 201 with the TPPP service for communicating the selection(s). User A registers/authenticates himself or herself to the TPPP service, but does not need to provide a specific PAN to the TPPP. For example, User A will choose a payment method (e.g., identification of Bank 1) to use for registering a payment instrument.

Similarly, the user connects to the Bank 1 Portal using connection 203 and provides Bank 1 with details regarding the TPPP, its authorized use of the PANs, including limits, if any. This independently links Bank 1 and TPPP.

Next, at 202, the TPPP service will use User A's selected payment method to redirect User A's browser to Bank 1 Portal to request authorization from Bank 1. It should be noted that redirection of a user browser is one of the ways that the context may be transferred between bank and TPPP. It is possible, for example, to translate the browser based workflows described herein to equivalent desktop or mobile application based workflows. As described in connection with step 103 of FIG. 1, User A must have provided Bank 1 with instructions on allowing TPPP access to Bank 1 instruments owned by User A. User A may also indicate details with respect to using the TPPP, e.g., providing spending limits, as illustrated by the communication with Bank 1 Portal in FIG. 2 at 203. This ensures that Bank 1 will know that User A is affiliated with Bank 1 and that the TPPP is affiliated with User A. At this time, the user may optionally assign easy to remember display names to each of his payment instrument.

Bank 1, having received the user request, e.g., via redirect 202 from a specific TPPP, will authenticate that User A and return user and instrument aliases (and display names if assigned) associated with User A at Bank 1, as illustrated at 204 of FIG. 2. Bank 1 has mapped the user and instrument aliases to a bank user, i.e., User A in this example, and PANs of User A, i.e., Card 1 and Card 2 in this example. The user and instrument aliases are provided to the TPPP such that these are used for subsequent payment processing requests by the TPPP rather than one or more actual PANs at Bank 1 for User A.

The lower portion of FIG. 2 illustrates how each entity sees or represents enrolled payment instruments. With reference to the illustration of FIG. 2, Bank 1 represents User A with a user ID, e.g., 505240. User A is thus associated by Bank 1 with his or her payment instruments, e.g., Cards 1 and 2 having actual PANs. This PAN information is stored at Bank 1 and is not released to the TPPP, as described herein. In contrast, the TPPP identifies User A with another identifier, e.g., User A0406. When communicating with Bank 1 (e.g. to process a payment), the TPPP will use the user alias obtained in 204 to identify User A. To identify specific instruments, the TPPP uses this alias along with instrument aliases for Card 1 and Card 2.

When User A is signed into the TPPP service, he or she views the bank instruments (identified by display names or partial PAN at the TPPP service web site or native application) and identifies them from use. The display names may be chosen by the User A (e.g., chosen by User A at Bank 1 Portal, as described herein, or as partial PANs (e.g., xxxx-xxxxxx-12345) generated by Bank 1).

Turning to FIG. 3, an example of making online payments is illustrated. After initiation of the TPPP, as outlined in connection with FIG. 1 and FIG. 2, a user may navigate to an online merchant's web site. In the checkout process, the user's shopping cart contains one or more items requiring payment. The shopping cart application permits the user to select a TPPP for processing the transaction, i.e., similar to conventional virtual wallet services supported by online merchants.

The user, at 301, therefore chooses a TPPP at checkout within the shopping cart application. The user authenticates (e.g., logs in) a single time to the TPPP at 302 and chooses a payment method, e.g., Instrument Alias 1 or Instrument Alias 2 as illustrated in FIG. 2. Having the selection of the user, the TPPP may then use the alias to request payment information from the bank at 303.

At the bank, the TPPP request will be evaluated and, subject to the request being found authentic and the transaction being consistent with the limits specified by the user, as determined in 304, the bank will issue payment information (e.g., confirmation of direct debit or confirmation of the user's ability to pay) on behalf of the user at 305. Otherwise, the bank will deny the payment request. The alias allows the bank to uniquely identify a payment instrument (PAN) owned by the user at the bank at 304. Whereas tokens or virtual card numbers are typically used to protect real card numbers being exposed to a merchant, in contrast, an embodiment uses aliases as a means to communicate to the bank that the user has already been authenticated by the TPPP. That is, the TPPP has previously authenticated the user by virtue of having the user and instrument aliases, as illustrated in FIG. 2. This avoids a need for the dual authentication (e.g., VERIFIED BY VISA processing, etc.).

The TPPP may then use the payment information to complete the payment on behalf of the user for processing the online payment with the shopping cart application. As will be appreciated by those having ordinary skill in the art, the payment processing may be a closed loop type of processing, e.g., a request by the TPPP to the bank for direct payment/debiting of the user's PAN, or may be an open loop type processing, whereby the TPPP interfaces with a network (e.g., VISA credit card network) to complete the transaction processing.

FIG. 4 provides an illustration of an example system network in which payment processing takes place, e.g., as illustrated in the example method of FIG. 3. As shown in FIG. 4, at 401, the user chooses a TPPP during a checkout procedure according to a shopping cart application (e.g., online, mobile device application, etc.). The shopping cart application communicates with the TPPP such that the user may, via the shopping cart application, authenticate to the TPPP and choose an alias/payment method available via the TPPP at 402, e.g. by selecting a displayed name or partial PAN.

The TPPP in turn uses the user alias and/or instrument alias, e.g., a bank generated alias for a PAN, to request, at 403, authorization from the bank to pay on behalf of the user. The (issuer) bank in turn checks that the user alias and TPPP have been previously authorized by the user at 404, and may additionally determine if any limit(s) (for example chosen by the user) are being honored for a particular instrument alias, and, if so, maps the instrument alias to a PAN of the (issuer) bank. Thereafter, the (issuer) bank communicates with the TPPP that the user is authorized for payment at 405. The communication at 405 may include issuing a virtual PAN for use in payment processing at a payment network such as MasterCard or Visa.

The TPPP may then communicate the payment information to the shopping cart application. As before, if the closed loop type payment is used, the (issuer) bank may be requested to directly debit the user's PAN. Alternatively, if an open loop payment technique is employed, the TPPP may interact with the credit card network at 406 to process the payment, e.g., using the credit card directory and merchant bank(s), as illustrated in the example.

If 3D secure payment processing is required, automatic redirects (not illustrated) between various entities such as the shopping cart application, TPPP, and (issuer) bank are utilized; otherwise, these internal network communications are not required. Further detailed description of the 3D secure technique is omitted in the interest of clarity of this disclosure; however, it is worth noting that given the relationship between the TPPP and the issuer bank, and given the separate initiation of the TPPP at the issuer bank by the user (e.g., at step 103 of FIG. 1), an automated compliance with 3D secure is enabled due to the fact that the TPPP may use the virtual card number to establish that the user has authorized the TPPP, as described in connection with FIG. 2.

As may be appreciated, the concept of limiting privileges delegated to the TPPP by the user at the time of registering a payment instrument with the TPPP is provided by an embodiment due to the user's direct communication with the bank (e.g., illustrated at step 103 of FIG. 1 and connection 203 of FIG. 2). Moreover, the user does not have to share sensitive payment information with TPPPs.

An embodiment also avoids a need for separate authorizations at the bank and the TPPP for the same transaction without requiring any changes to prominent card payment protocols. This also allows TPPPs to maintain their value proposition of providing simplified checkout for merchant websites. Moreover, compliance requirements for TPPPs may be significantly relaxed since they do not need to handle PAN data but rather deal with customer aliases.

Turning now to FIG. 5, computer system/server 512 in computing node 510 is shown in the form of a general-purpose computing device. The components of computer system/server 512 may include, but are not limited to, at least one processor or processing unit 516, a system memory 528, and a bus 518 that couples various system components including system memory 528 to processor 516. Bus 518 represents at least one of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 512 typically includes a variety of computer system readable media. Such media may be any available media that are accessible by computer system/server 512, and include both volatile and non-volatile media, removable and non-removable media.

System memory 528 can include computer system readable media in the form of volatile memory, such as random access memory (RAM) 530 and/or cache memory 532. Computer system/server 512 may further include other removable/non-removable, volatile/non-volatile computer system storage media. By way of example only, storage system 534 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 518 by at least one data media interface. As will be further depicted and described below, memory 528 may include at least one program product having a set (e.g., at least one) of program modules that are configured to carry out the functions of embodiments of the invention.

Program/utility 540, having a set (at least one) of program modules 542, may be stored in memory 528 (by way of example, and not limitation), as well as an operating system, at least one application program, other program modules, and program data. Each of the operating systems, at least one application program, other program modules, and program data or some combination thereof, may include an implementation of a networking environment. Program modules 542 generally carry out the functions and/or methodologies of embodiments of the invention as described herein.

Computer system/server 512 may also communicate with at least one external device 514 such as a keyboard, a pointing device, a display 524, etc.; at least one device that enables a user to interact with computer system/server 512; and/or any devices (e.g., network card, modem, etc.) that enable computer system/server 512 to communicate with at least one other computing device. Such communication can occur via I/O interfaces 522. Still yet, computer system/server 512 can communicate with at least one network such as a local area network (LAN), a general wide area network (WAN), and/or a public network (e.g., the Internet) via network adapter 520. As depicted, network adapter 520 communicates with the other components of computer system/server 512 via bus 518. It should be understood that although not shown, other hardware and/or software components could be used in conjunction with computer system/server 512. Examples include, but are not limited to: microcode, device drivers, redundant processing units, external disk drive arrays, RAID systems, tape drives, and data archival storage systems, etc.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method of third party assisted online payment processing, comprising:
utilizing at least one processor to execute computer code that performs steps comprising:
receiving, at a third party payment provider, a user selection communicated through an on-line shopping cart of a merchant, wherein the user selection identifies a bank and an alias;
communicating to the bank associated with the user selection, using a network connection between the third party payment provider and the bank, the alias and an identification of the third party payment provider;
receiving from the bank, at the third party payment provider and in response to the communicating, authorization for payment on behalf of the user; and
providing, to the on-line shopping cart of the merchant, payment information;
wherein the third party payment provider does not receive at any time a primary account number of the bank issued to the user.

2. The method of claim 1, wherein the communicating comprises requesting direct payment by the bank against an instrument identified by the alias.

3. The method of claim 1, wherein:
the communicating comprises requesting a virtual card number from the bank for the alias; and
the receiving comprises receiving the virtual card number associated with the alias.

4. The method of claim 1, wherein the alias is associated with a limited use of the primary account number of the bank issued to the user.

5. The method of claim 4, wherein the limited use is a predefined spending limit.

6. The method of claim 1, wherein the payment information comprises confirmation of payment.

7. The method of claim 1, comprising initiating the third party payment provider, the initiating comprising:
receiving from the user, at the third party payment provider, an indication of one or more banks to be used in online payment transactions;
communicating to the one or more banks, by the third party payment provider, a request for the alias; and
receiving the alias from the one or more banks.

8. The method of claim 7, wherein the third party payment provider stores a plurality of instrument aliases that a user may select.

9. The method of claim 1, wherein the alias identifies the user.

10. The method of claim 7, wherein the alias identifies a payment instrument selected by the user.

11. The method of claim 7, where no third party payment provider authorizations are associated with the alias and wherein the alias identifies a payment instrument in a subsequent transaction.

12. The method of claim 7, where the alias is used to obtain a virtual card number for a point of sale transaction.

13. An apparatus for third party assisted online payment processing, the apparatus comprising:
at least one processor; and
a computer readable storage medium having computer readable program code embodied therewith that is executable by the at least one processor, the computer readable program code comprising:
computer readable program code that receives, at a third party payment provider, a user selection communicated through an on-line shopping cart of a merchant, wherein the user selection identifies a bank and an alias;
computer readable program code that communicates to the bank associated with the user selection, using a network connection between the third party payment provider and the bank, the alias and an identification of the third party payment provider;
computer readable program code that receives from the bank, at the third party payment provider and in response to the communicating, authorization for payment on behalf of the user; and
computer readable program code that provides, to the on-line shopping cart of the merchant, payment information;
wherein the third party payment provider does not receive at any time a primary account number of the bank issued to the user.

14. A computer program product for third party assisted online payment processing, the computer program product comprising:
a computer readable storage medium having computer readable program code embodied therewith, the computer readable program code being executable by a processor and comprising:
computer readable program code that receives, at a third party payment provider, a user selection communicated through an on-line shopping cart of a merchant, wherein the user selection identifies a bank and an alias;
computer readable program code that communicates to the bank associated with the user selection, using a network connection between the third party payment provider and the bank, the alias and an identification of the third party payment provider;
computer readable program code that receives from the bank, at the third party payment provider and in response to the communicating, authorization for payment on behalf of the user; and
computer readable program code that provides, to the on-line shopping cart of the merchant, payment information;
wherein the third party payment provider does not receive at any time a primary account number of the bank issued to the user.

15. The computer program product of claim 14, wherein communication to the bank comprises requesting direct payment by the bank for the alias.

16. The computer program product of claim 14, wherein:
the communication to the bank comprises requesting a virtual card number from the bank for the alias; and
the virtual card number associated with the user alias is received from the bank.

17. The computer program product of claim 14, wherein the alias is associated with a limited use of the primary account number of the bank issued to the user.

18. The computer program product of claim 17, wherein the limited use is a predefined spending limit.

19. The computer program product of claim 14, wherein the payment information comprises confirmation of payment.

20. The computer program product of claim 14, further comprising computer readable program code that initiates the third party payment provider, comprising:
computer readable program code that receives from the user, at the third party payment provider, an indication of one or more banks to be used in online payment transactions;
computer readable program code that communicates to the one or more banks, by the third party payment provider, a request for the user alias; and
computer readable program code that receives the alias from the one or more banks.

21. The computer program product of claim 20, wherein the third party payment provider stores a plurality of instrument aliases that a user may select.

22. A method of third party assisted online payment processing, comprising:
utilizing at least one processor to execute computer code that performs steps comprising:
initiating a third party payment provider, the initiating comprising:
receiving from a user, at the third party payment provider, an indication of one or more banks to be used in online payment transactions;
redirecting, from the third party payment provider, the user to a bank portal of the one or more banks; and
receiving, at the third party payment provider, an alias from the one or more banks;
thereafter receiving, at the third party payment provider, a user selection communicated through an on-line shopping cart of a merchant, wherein the user selection identifies a bank and an alias;
communicating to the bank associated with the user selection, using a network connection between the third party payment provider and the bank, the alias and an identification of the third party payment provider;
receiving from the bank, at the third party payment provider and in response to the communicating, authorization for payment on behalf of the user; and
providing, to the on-line shopping cart of the merchant, payment information;
wherein the third party payment provider does not receive at any time a primary account number of the bank issued to the user.
